(19) United States
(12) Patent Application Publication
(10) Pub. No.: US 2021/0259349 A1
(43) Pub. Date: Aug. 26, 2021

(54) Light Reflecting Headgear Assembly

(71) Applicants: James Sanchez, Cottonwood, AZ (US); Carolyn Green, Cottonwood, AZ (US)

(72) Inventors: James Sanchez, Cottonwood, AZ (US); Carolyn Green, Cottonwood, AZ (US)

(21) Appl. No.: 16/796,531

(22) Filed: Feb. 20, 2020

(51) Int. Cl. A42B 3/06; G02B 5/128; A45B 3/02; A45B 9/02

(52) U.S. Cl. CPC A42B 3/061; G02B 5/128; A45B 2200/05; A45B 9/02; A45B 3/02

(57) ABSTRACT

A light reflecting headgear assembly includes an article of headgear that is wearable on a user's head. The article of headgear is comprised of a rigid material to protect the user's head from impact. A substrate is coupled on the article of headgear and a plurality of beads is each partially embedded into the substrate. Each of the beads is comprised of a translucent material to pass light therethrough. Each of the beads is partially embedded into the substrate to reflect light for enhancing visibility of the article of headgear in a darkened environment. A covering layer is positioned over the plurality beads and the covering layer is comprised of a translucent material to pass light therethrough.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to reflecting devices and more particularly pertains to a new reflecting device for enhancing visibility of an article of head gear in a darkened environment.

### (2) Description of Related Art Including Information Disclosed Under 37 CFR 1.97 and 1.98

The prior art relates to reflecting devices. The prior art discloses a helmet that has a heat reflecting layer positioned thereon for reflecting sunlight to reduce thermal transfer to a user. Additionally, the prior art discloses a variety of helmets that each have reflectors integrated therein for enhancing visibility of the helmets at night. In each case the reflectors are bonded in some fashion to an outer surface of the helmet. The prior art discloses a helmet that has a binding layer thereon, a plurality of microspheres being embedded into the binding layer for reflecting light and a protective layer extending over the microspheres. The covering layer rests on each of the microspheres and no grid is present within the covering layer. None of the prior art discloses a helmet, a substrate, a plurality of beads, a covering layer and a grid integrated into the covering layer.

### BRIEF SUMMARY OF THE INVENTION

An embodiment of the disclosure meets the needs presented above by generally comprising an article of headgear that is wearable on a user's head. The article of headgear is comprised of a rigid material to protect the user's head from impact. A substrate is coupled on the article of headgear and a plurality of beads is each partially embedded into the substrate. Each of the beads is comprised of a translucent material to pass light therethrough. Each of the beads is partially embedded into the substrate to reflect light for enhancing visibility of the article of headgear in a darkened environment. A covering layer is positioned over the plurality beads and the covering layer is comprised of a translucent material to pass light therethrough.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a light reflecting headgear assembly according to an embodiment of the disclosure.

FIG. 2 is a front view of an embodiment of the disclosure.

FIG. 3 is a perspective view of an alternative embodiment of the disclosure.

FIG. 4 is a front view of an alternative embodiment of the disclosure.

FIG. 5 is a front perspective view of an embodiment of the disclosure.

FIG. 6 is a perspective in-use view of an embodiment of the disclosure.

FIG. 7 is a detail view taken from circle 7 of FIG. 2 of an embodiment of the disclosure.

### DETAILED DESCRIPTION OF THE INVENTION

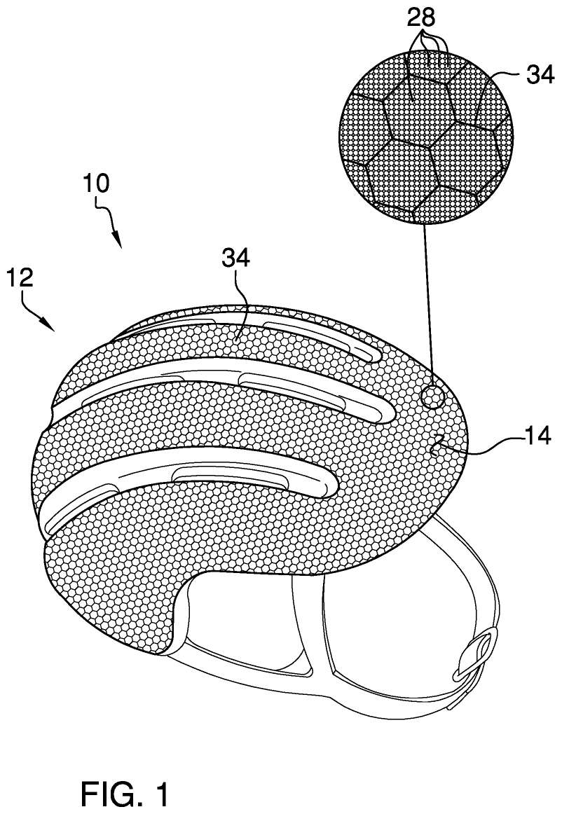

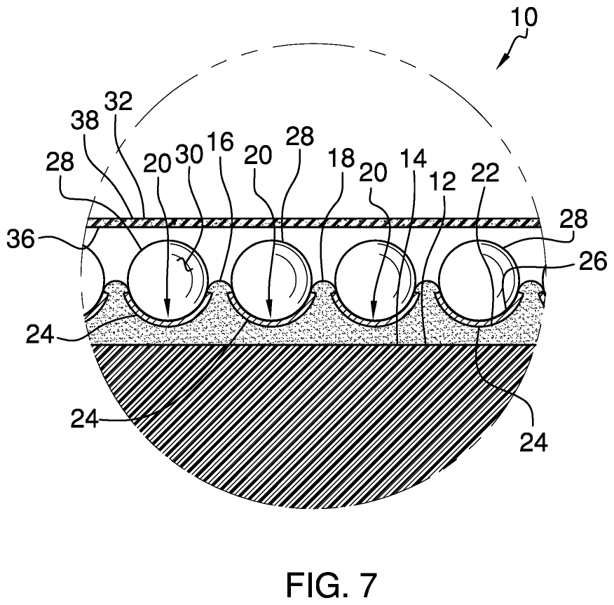

With reference now to the drawings, and in particular to FIGS. 1 through 7 thereof, a new reflecting device embodying the principles and concepts of an embodiment of the disclosure and generally designated by the reference numeral 10 will be described.

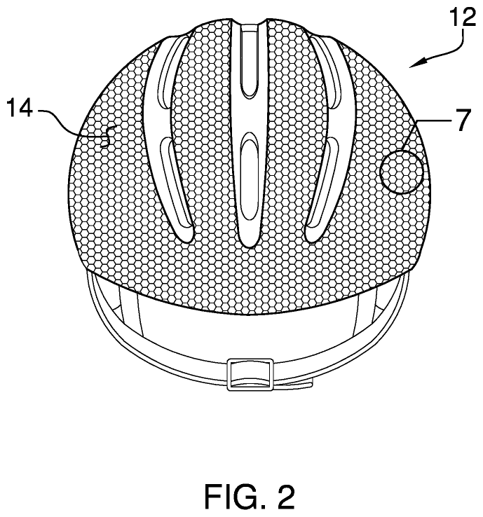

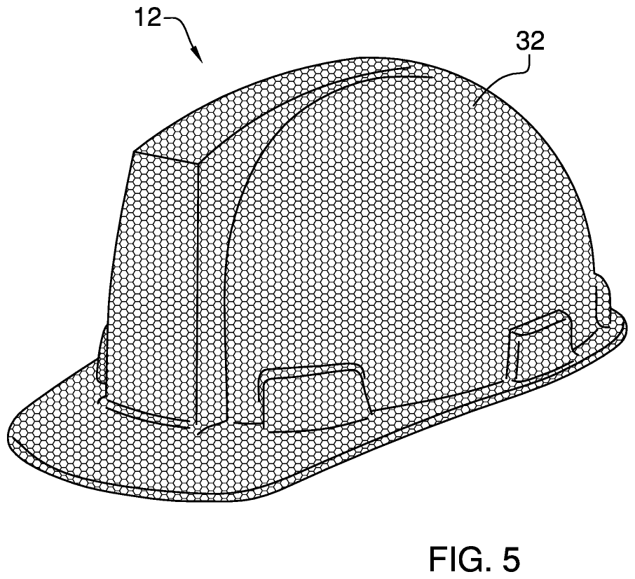

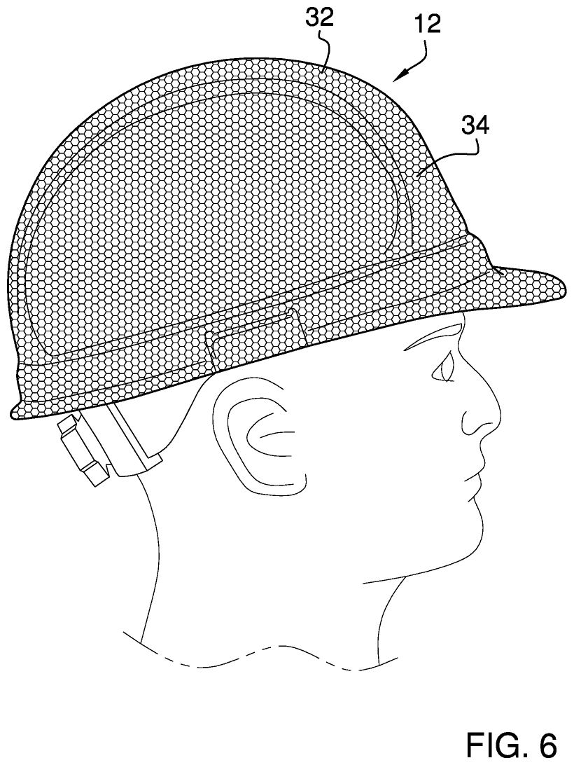

As best illustrated in FIGS. 1 through 7, the light reflecting headgear assembly 10 generally comprises an article of headgear 12 that is wearable on a user's head. The article of headgear 12 is comprised of a rigid material to protect the user's head from impact and the article of headgear 12 has an outwardly facing surface 14. As is most clearly shown in FIGS. 1 and 2, the article of headgear 12 may be a bicycle helmet. As is most clearly shown in FIGS. 5 and 6, the article of headgear 12 may be an OSHA approved construction helmet.

A substrate 16 is coupled on the article of headgear 12 and the substrate 16 completely covers the outwardly facing surface 14. The substrate 16 has an exposed surface 18 that is exposed with respect to the outwardly facing surface 14. Moreover, the exposed surface 18 has a plurality of depressions 20 therein each extending toward the outwardly facing surface 14. The depressions 20 are spaced apart from each other and are distributed over an entirety of the exposed surface 18. Additionally, each of the depressions 20 has a bounding surface 22 and the bounding surface 22 is concavely arcuate with respect to the exposed surface 18 such that each of the depressions 20 has a hemispherical shape. The substrate 16 may be a hardening material, such as a clay like material, that hardens after the substrate 16 is formed into a preferred shape.

A plurality of mating members 24 is provided and each of the mating members 24 is positioned in a respective one of the depressions 20. Each of the mating members 24 is bonded to the bounding surface 22 of the respective depression 20. Additionally, each of the mating members 24 has a top surface 26 that is exposed in the respective depression 20. Each of the mating members 24 may comprise an adhesive layer or other similar type of mating member that is capable of securely engaging a smooth, curved surface.

A plurality of beads 28 is provided and each of the beads 28 is comprised of a translucent material to pass light therethrough. Each of the beads 28 has a continuously arcuate outer surface 30 such that each of the beads 28 has a spherical shape. In this way each of the beads 28 will reflect the light outwardly therefrom. Each of the beads 28 is partially embedded into the substrate 16 to reflect light for enhancing visibility of the article of headgear 12 in a darkened environment. In this way the beads 28 enhance safety for a person wearing the article of headgear 12 with respect to being visible to traffic at night or other similar occasion that involved limited visibility posing a danger to the person wearing the article of headgear 12. Each of the mating members 24 engages the outer surface 30 of a respective one of the beads 28 for retaining the respective bead 28 in the respective depression 20.

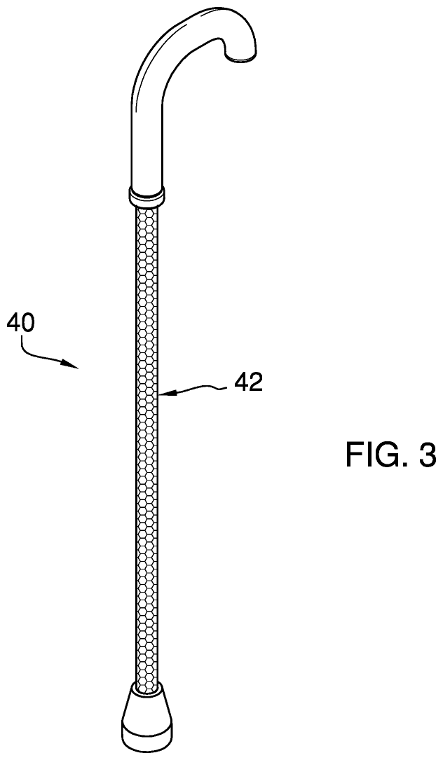

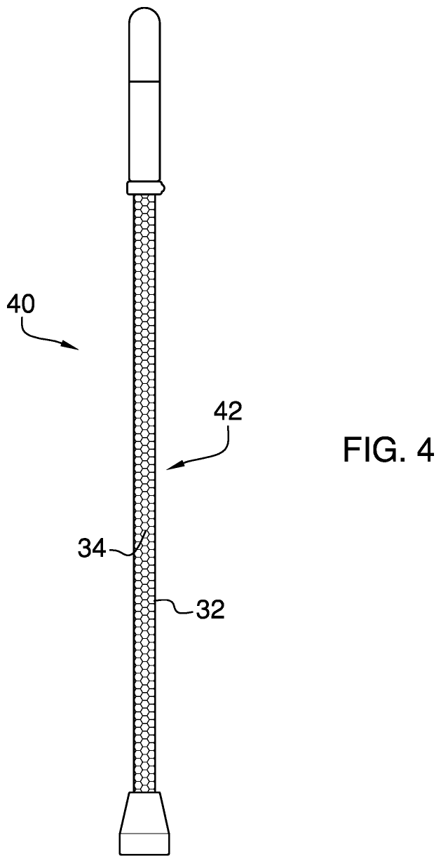

A covering layer 32 is provided and the covering layer 32 is positioned over the plurality beads 28. The covering layer 32 includes a grid 34 that is structured to define a honeycomb pattern and the covering layer 32 is comprised of a translucent material to pass light therethrough. The covering layer 32 has a lower surface 36 and an upper surface 38, and the lower surface 36 is directed toward the outer surface 30 of each of the beads 28. Moreover, the grid 34 is positioned between the lower surface 36 and the upper surface 38. In an alternative embodiment 40 as is most clearly shown in FIGS. 3 and 4, a walking cane 42 is provided and the substrate 16, each of the mating members 24, each of the beads 28 and the covering layer 32 are positioned around the walking cane 42 for enhancing visibility of the walking cane 42 at night.

In use, the article of headgear 12 is worn in the conventional manner for conventional purposes. Each of the beads 28 reflects light outwardly therefrom when the beads 28 are exposed to light. In this way the beads 28 enhance visibility of the article of headgear 12 in a darkened environment, such as nighttime, to enhance safety for the person wearing the article of headgear 12. Additionally, the covering layer 32 protects the beads 28 from impact damage, from scratches and from dirt thereby facilitating the beads 28 to reflect light in sufficient intensity.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A light reflecting headgear assembly having a plurality of reflective beads being embedded therein for reflecting light, said assembly comprising:
an article of headgear being wearable on a user's head, said article of headgear being comprised of a rigid material wherein said article of headgear is configured to protect the user's head from impact;
a substrate being coupled on said article of headgear;
a plurality of beads, each of said beads being comprised of a translucent material wherein each of said beads is configured to pass light therethrough, each of said beads having a continuously arcuate outer surface such that each of said beads has a spherical shape wherein each of said beads is configured to reflect the light outwardly therefrom, each of said beads being partially embedded into said substrate wherein each of said beads is configured to reflect light for enhancing visibility of said article of headgear in a darkened environment; and
a covering layer being positioned over said plurality beads, said covering layer including a grid defining a honeycomb pattern, said covering layer being comprised of a translucent material wherein said covering layer is configured to pass light therethrough.

2. The assembly according to claim 1, wherein:
said article of headgear has an outwardly facing surface;
said substrate completely covers said outwardly facing surface, said substrate having an exposed surface being exposed with respect to said outwardly facing surface, said exposed surface having a plurality of depressions therein each extending toward said outwardly facing surface, said depressions being spaced apart from each other and being distributed over an entirety of said exposed surface.

3. The assembly according to claim 1, wherein said substrate has a plurality of depressions each extending into an exposed surface of said substrate, each of said depressions having a bounding surface, said bounding surface being concavely arcuate with respect to said exposed surface such that each of said depressions has a hemispherical shape.

4. The assembly according to claim 3, further comprising a plurality of mating members, each of said mating members being positioned in a respective one of said depressions, each of said mating members being bonded to said bounding surface of said respective depression, each of said mating members having a top surface being exposed in said respective depression.

5. The assembly according to claim 4, wherein each of said mating members engages said outer surface of a respective one of said beads for retaining said respective bead in said respective depression.

6. The assembly according to claim 1, wherein said covering layer has a lower surface and an upper surface, said lower surface being directed toward said outer surface of each of said beads, said grid being positioned between said lower surface and said upper surface.

7. A light reflecting headgear assembly having a plurality of reflective beads being embedded therein for reflecting light, said assembly comprising:
an article of headgear being wearable on a user's head, said article of headgear being comprised of a rigid material wherein said article of headgear is configured to protect the user's head from impact, said article of headgear having an outwardly facing surface;
a substrate being coupled on said article of headgear, said substrate completely covering said outwardly facing surface, said substrate having an exposed surface being exposed with respect to said outwardly facing surface, said exposed surface having a plurality of depressions therein each extending toward said outwardly facing surface, said depressions being spaced apart from each other and being distributed over an entirety of said exposed surface, each of said depressions having a bounding surface, said bounding surface being concavely arcuate with respect to said exposed surface such that each of said depressions has a hemispherical shape;
a plurality of mating members, each of said mating members being positioned in a respective one of said depressions, each of said mating members being bonded to said bounding surface of said respective depression, each of said mating members having a top surface being exposed in said respective depression;
a plurality of beads, each of said beads being comprised of a translucent material wherein each of said beads is configured to pass light therethrough, each of said beads having a continuously arcuate outer surface such that each of said beads has a spherical shape wherein each of said beads is configured to reflect the light outwardly therefrom, each of said beads being partially embedded into said substrate wherein each of said beads is configured to reflect light for enhancing visibility of said article of headgear in a darkened environment, each of said mating members engaging said outer surface of a respective one of said beads for retaining said respective bead in said respective depression; and
a covering layer being positioned over said plurality beads, said covering layer including a grid defining a honeycomb pattern, said covering layer being comprised of a translucent material wherein said covering layer is configured to pass light therethrough, said covering layer having a lower surface and an upper surface, said lower surface being directed toward said outer surface of each of said beads, said grid being positioned between said lower surface and said upper surface.

8. The assembly according to claim 7, further comprising a walking cane having a handle portion, said substrate, each of said mating members, each of said beads and said covering layer being positioned around said handle portion wherein said walking cane is configured to be visible in a darkened environment.
